(19) United States
(12) Patent Application Publication
(10) Pub. No.: US 2022/0404568 A1
(43) Pub. Date: Dec. 22, 2022

(54) PACKAGE WITH OPTICAL WAVEGUIDE IN A GLASS CORE

(71) Applicant: Intel Corporation, Santa Clara, CA (US)

(72) Inventors: Aleksandar ALEKSOV, Chandler, AZ (US); Telesphor KAMGAING, Chandler, AZ (US); Veronica STRONG, Hillsboro, OR (US); Neelam PRABHU GAUNKAR, Chandler, AZ (US); Georgios C. DOGIAMIS, Chandler, AZ (US)

(21) Appl. No.: 17/350,809

(22) Filed: Jun. 17, 2021

(51) Int. Cl. G02B 6/42

(52) U.S. Cl. CPC G02B 6/4246; G02B 6/4253

(57) ABSTRACT

Embodiments disclosed herein include electronic packages with a core that includes an optical waveguide and methods of forming such electronic packages. In an embodiment, a package substrate comprises a core, and a photonics die embedded in the core. In an embodiment, the electronic package further comprises an optical waveguide embedded in the core. In an embodiment, the optical waveguide optically couples the photonics die to an edge of the core.

### TECHNICAL FIELD

Embodiments of the present disclosure relate to electronic packages, and more particularly to package substrates with a glass core with embedded optical waveguides.

### BACKGROUND

With a surge in demand for high-speed communication services, low latency solutions with high data rates and bandwidth density have emerged as critical product differentiators. One high bandwidth communication architecture is optical communications. Optical communications are typically used for large distances. However, the high bandwidth associated with optical interconnects and communication are attracting increased interest for implementation to shorter distances, such as socket-to-socket, socket-to-board/memory, or board-to-board. Integrating optical components onto packages (e.g., dies, package substrates, sockets, etc.) seamlessly and with a minimum of losses and high density for maximized bandwidth is very challenging.

Current approaches for optical communications on package rely on edge emitting lasers. This limits the bandwidth of beams per cm² since a single row of laser are provided instead of an array (as is possible with vertical-cavity surface-emitting lasers (VCSELs)). Additionally, existing integration schemes rely on direct waveguide alignment to the edge emitting laser with extraordinarily high precision. This puts significant demand on assembly. Additionally, the integration schemes include laser dies that are positioned on the surface of the package. This is the only way the laser or photodiode dies can be close to the edge, minimizing the need for optical fiber routing over the package. This results in additional assembly precision and connectivity issues.

### BRIEF DESCRIPTION OF THE DRAWINGS

FIG. 1A is a cross-sectional illustration of a glass core with top and bottom surfaces that are being exposed with a laser, in accordance with an embodiment.

FIG. 1B is a cross-sectional illustration of the glass core with regions that have their morphology altered by the laser, in accordance with an embodiment.

FIG. 1C is a cross-sectional illustration of the glass core with a via hole through a thickness of the glass core, in accordance with an embodiment.

FIG. 1D is a cross-sectional illustration of the glass core with a via through the thickness of the glass core, in accordance with an embodiment.

FIG. 2A is a plan view illustration of the glass core with a plurality of circular vias, in accordance with an embodiment.

FIG. 2B is a plan view illustration of the glass core with a vertical via plane, in accordance with an embodiment.

FIG. 3A is a cross-sectional illustration of an electronic package with horizontal optical waveguides embedded in a core of the package substrate, in accordance with an embodiment.

FIG. 3B is a cross-sectional illustration of an electronic package with vertical optical waveguides embedded in a core of the package substrate, in accordance with an embodiment.

FIG. 3C is a cross-sectional illustration of an electronic package with vertical optical waveguides between a transceiver die and a connector, in accordance with an embodiment.

FIG. 3D is a cross-sectional illustration of an electronic package with a transceiver die on a bottom of a package substrate and a die over a top of the package substrate, in accordance with an embodiment.

FIG. 3E is a cross-sectional illustration of an electronic package with a transceiver die integrated with a connector, in accordance with an embodiment.

FIG. 4A is a cross-sectional illustration of an electronic package with embedded optical waveguides and an embedded mirror, in accordance with an embodiment.

FIG. 4B is a cross-sectional illustration of an electronic package with embedded optical waveguides and a plurality of embedded mirrors, in accordance with an embodiment.

FIG. 4C is a plan view illustration of the mirrors in FIG. 4B, in accordance with an embodiment.

FIG. 4D is a cross-sectional illustration of an electronic package with embedded optical waveguides and a plurality of embedded mirrors at opposite angles, in accordance with an embodiment.

FIG. 4E is a plan view illustration of the mirrors in FIG. 4D, in accordance with an embodiment.

FIG. 5A is a plan view illustration of a core with embedded optical waveguides that have a first pitch near the edge of the core and a second pitch near a mirror, in accordance with an embodiment.

FIG. 5B is a cross-sectional illustration of a core with embedded optical waveguides that pass through different z-heights in the core, in accordance with an embodiment.

FIG. 5C is a cross-sectional illustration of a core with embedded optical waveguides that have a turn, in accordance with an embodiment.

FIG. 6A is a cross-sectional illustration of a core with slots for receiving a connector, in accordance with an embodiment.

FIG. 6B is a zoomed in illustration of the slots and the connector, in accordance with an embodiment.

FIGS. 7A-7F are cross-sectional illustrations depicting a process for forming the slots in a core, in accordance with an embodiment.

FIG. 8 is a cross-sectional illustration of an electronic package with a core that comprises slots for receiving a connector, in accordance with an embodiment.

FIG. 9 is a schematic of a computing device built in accordance with an embodiment.

### EMBODIMENTS OF THE PRESENT DISCLOSURE

Described herein are package substrates with a glass core with embedded optical waveguides, in accordance with various embodiments. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

As noted above, integration of optical interconnects within the electronic package is challenging due to architecture and assembly issues. Accordingly, embodiments disclosed herein include optical waveguides that are embedded in a core of the package substrate. Particularly, the optical waveguides are fabricated in the core by a laser-assisted process. In an embodiment, glass cores are used. The glass can be exposed to a laser in order to create a morphological change in the glass. For example, the exposed glass may be converted from an amorphous crystal structure to a crystalline crystal structure. The change in crystal structure results in a change in the index of refraction (making the index of refraction higher) and allows for total internal reflection. The depth, shape, and form of the optical waveguide may be controlled by adjusting the laser focus and the guidance of the laser across the core. The enhanced routing architectures may be particularly beneficial for allowing VCSEL integration as opposed to only edge emitting lasers.

Laser-assisted etching processes may also be used in order to fabricate structures in the core used for routing the optical signals. For example, angled features, such as angled mirrors, may be fabricated in the core to reflect and direct the optical signals to an optical transceiver (TRX) die. Additional embodiments may include fabrication of slots along the edge of the core. The slots may optically couple external fibers to the optical waveguides in the core.

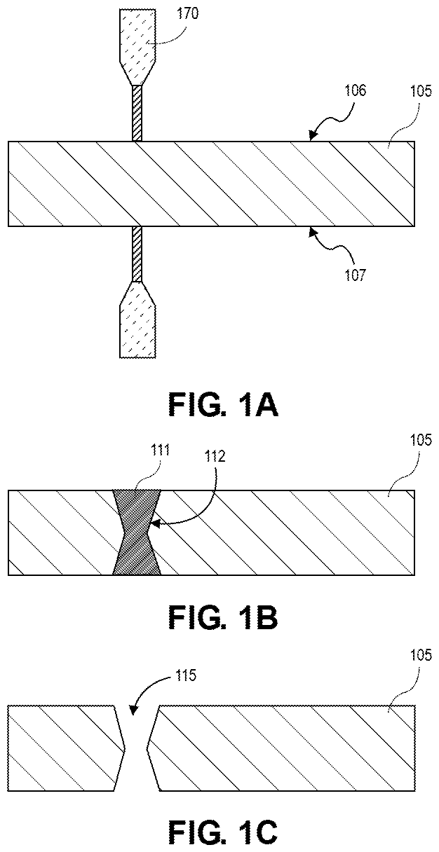

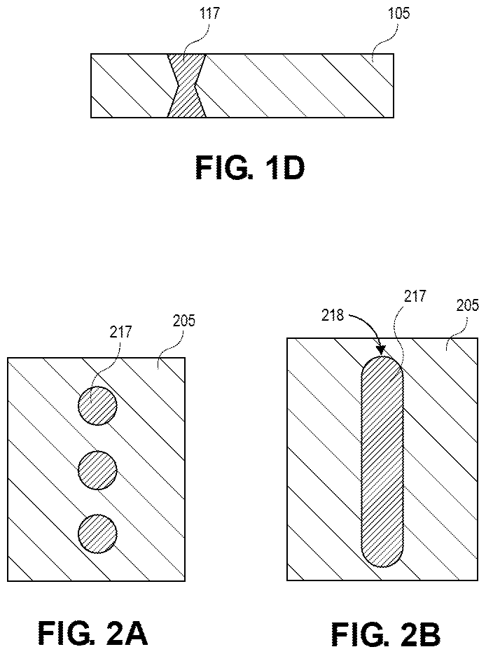

Referring now to FIGS. 1A-1D, a series of cross-sectional illustrations depicting a laser-assisted etching process to form features in a package core is shown, in accordance with an embodiment. The laser-assisted etching process may be used to form various features (e.g., the conductive vias and mirrors) described herein. Additionally, the initial stage of the laser-assisted etching process may be used to fabricate embedded optical waveguides. As shown in FIG. 1A, the package core 105 is exposed by a laser 170. The laser 170 may be irradiated over both a first surface 106 and a second surface 107. However, the laser 170 may only irradiate a single surface of the package core 105 in other embodiments.

In an embodiment, the package core 105 may comprise a material that is capable of forming a morphological change as a result of the exposure by the laser 170. For example, in the case of a glass package core 105, the morphological change may result in the conversion of an amorphous crystal structure to a crystalline crystal structure. In an embodiment, the package core 105 may have a thickness between the first surface 106 and the second surface 107 that is between 100 μm and 1,000 μm. However, it is to be appreciated that larger or smaller thicknesses may also be used for the package core 105 in other embodiments.

Referring now to FIG. 1B, a cross-sectional illustration of the package core 105 after the morphological change has occurred is shown, in accordance with an embodiment. As shown, an exposed region 111 is provided through a thickness of the package core 105. In an embodiment, the exposed region 111 may have sidewalls 112 that are sloped. That is, the sidewalls 112 may not be substantially vertical (with respect to the first surface 106 and the second surface 107). In a particular embodiment, the exposed region 111 may have an hourglass shaped cross-section that results from exposure on both the first surface 106 and the second surface 107. As used herein, an hourglass shaped cross section may refer to a shape that starts with a first width on a first end, decreases in width while moving away from the first end until reaching a minimum width between the first end and a second end, and increasing in width while moving from the minimum width in the middle towards the second end. That is, the shape may have a middle region that is narrower in width than the widths of the opposing ends. In an embodiment, the sidewalls 112 may have a slope that is approximately 10° or less away from vertical. While shown with sloped sidewalls 112, it is also to be appreciated that embodiments may include substantially vertical sidewalls depending on the laser parameters and the material of the package core 105.

While shown as providing an exposed region 111 that passes through an entire thickness of the package core 105, it is to be appreciated that laser parameters may be modified in order to provide different structures. For example, a blind structure may be formed. A blind structure extends into, but not through, the package core 105. Furthermore, while shown as being substantially vertically oriented, the exposed region 111 may be at an angle with respect to a surface of the package core 105. For example, a 45° angle may be used to form angled mirror features, as will be described in greater detail below.

Additionally, buried structures may also be provided by the laser exposure. A buried structure is an exposed region 111 that is surrounded on all sides by the unexposed package core 105. For example, adjustments to the focus of the laser may be used to fabricate buried features. In an embodiment, the buried features may be used as optical waveguides, as will be described in greater detail below. When used as an optical waveguide, the processing may cease after the laser exposure. In order to protect the optical waveguide from subsequent etching and plating processes, the optical waveguide may be covered by a mask layer or the like.

Referring now to FIG. 1C, a cross-sectional illustration of the package core 105 after the exposed region 111 is removed to form a hole 115 through the package core 105 is shown, in accordance with an embodiment. In an embodiment, the hole 115 may be formed with an etching process that is selective to the exposed region 111 over the remainder of the package core 105. The etch selectivity of the exposed region 111 to the remainder of the package core 105 may be 10:1 or greater, or 50:1 or greater. That is, while selective to the exposed region 111, some portion of the package core 105 may also be etched, resulting in the thickness of the package core 105 being slightly reduced. In an embodiment, the etchant may be a wet etching chemistry.

Referring now to FIG. 1D, a cross-sectional illustration of the core substrate 105 after a via 117 is formed in the hole 115 is shown, in accordance with an embodiment. In an embodiment, the via 117 may be deposited with a plating process or any other suitable deposition process. In an embodiment, the hole 115 may have a maximum diameter that is approximately 100 μm or less, approximately 50 μm or less, or approximately 10 μm or less. The pitch between individual holes 115 in the package core 105 may be between approximately 10 μm and approximately 100 μm in some embodiments. The small diameters and pitch (compared to traditional plated through hole (PTH) vias that typically have diameters that are 100 μm or larger and pitches that are 100 μm or larger) allow for high density integration of vias.

In FIGS. 1A-1D only a single cross-section of the package core 105 is shown for simplicity. However, it is to be appreciated that the shape of the vias 117 may take substantially any form. This is because the laser providing the morphological change in the package core 105 may be moved in a controllable manner. Examples of various plan views of a via 217 in a package core 205 are shown in FIGS. 2A and 2B.

Referring now to FIG. 2A, a plan view illustration of a package core 205 with a plurality of circular vias 217 is shown, in accordance with an embodiment. While three vias 217 are shown, it is to be appreciated that any number of vias 217 may be provided in any configuration.

Referring now to FIG. 2B, a plan view illustration of a package core 205 with a via 217 that is extended along one direction is shown, in accordance with an embodiment. Such a via 217 may be referred to herein as a “via plane” or simply a “plane”. The via plane 217 may have a thickness through the package core 205 that is substantially uniform, while also being extended in a direction, as opposed to having a width and length that are substantially uniform. As shown in FIG. 2B, the ends of the via structure 217 may be rounded surfaces 218. The rounded surfaces may be the result of the shape of the laser irradiation. That is, the focus of the laser may be substantially circular in some embodiments. Via planes may be used to form features such as a embedded mirrors, as will be described in greater detail below.

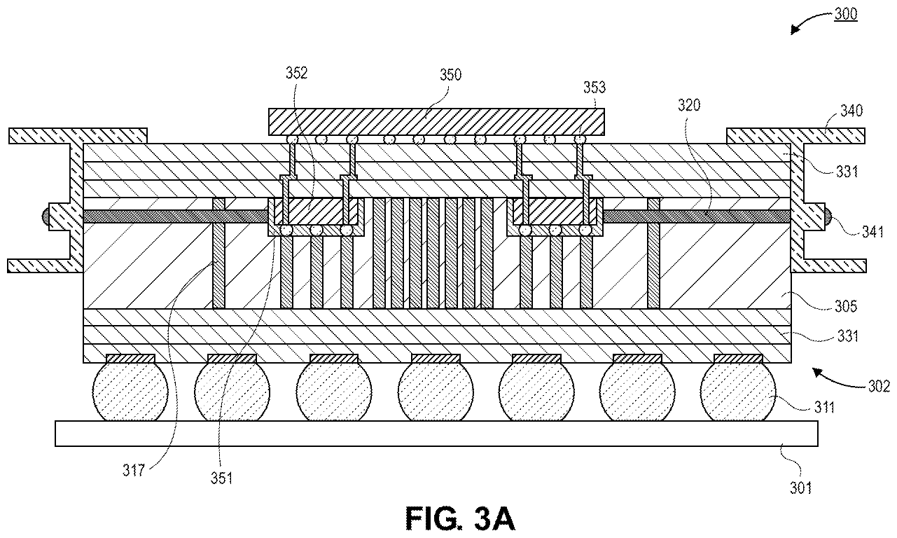

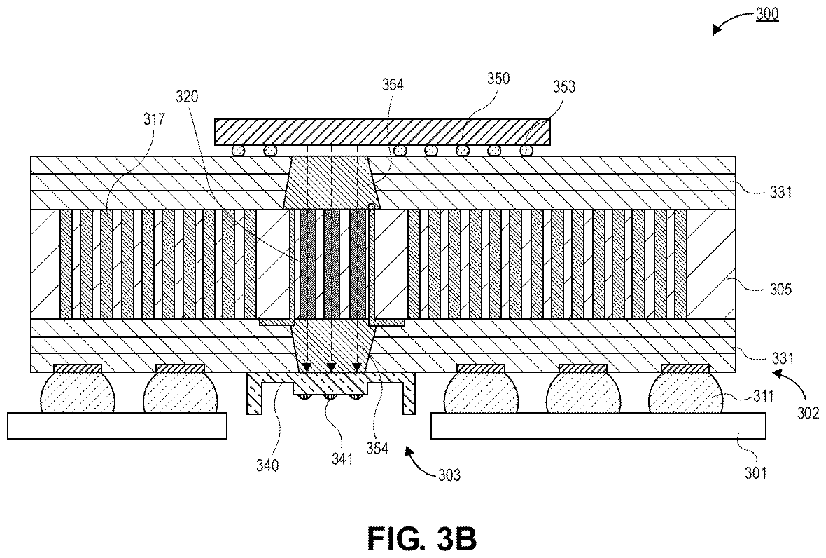

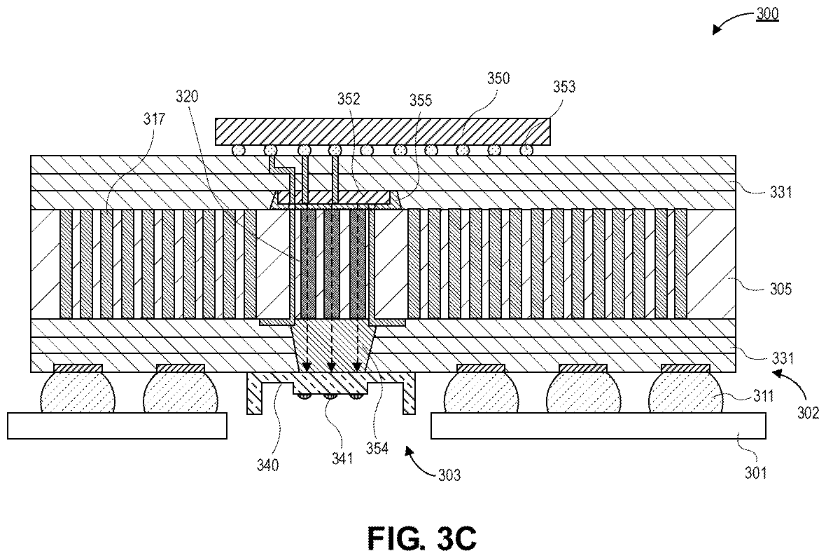

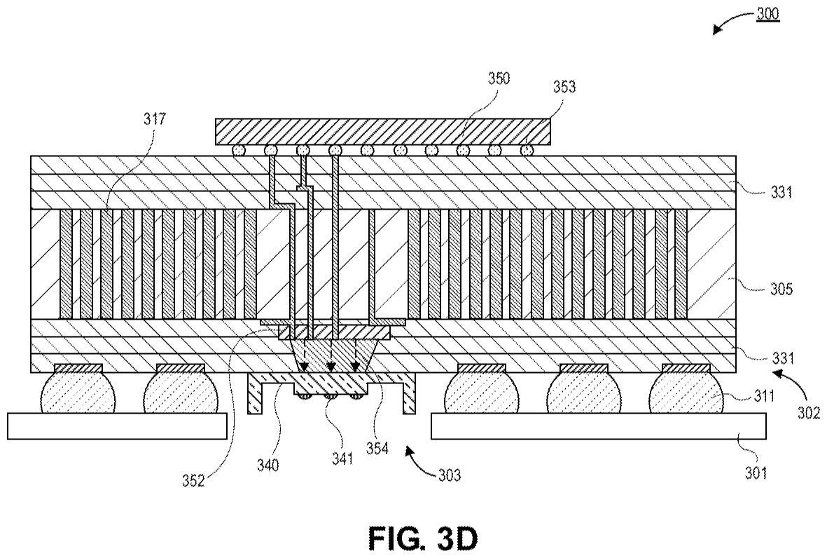

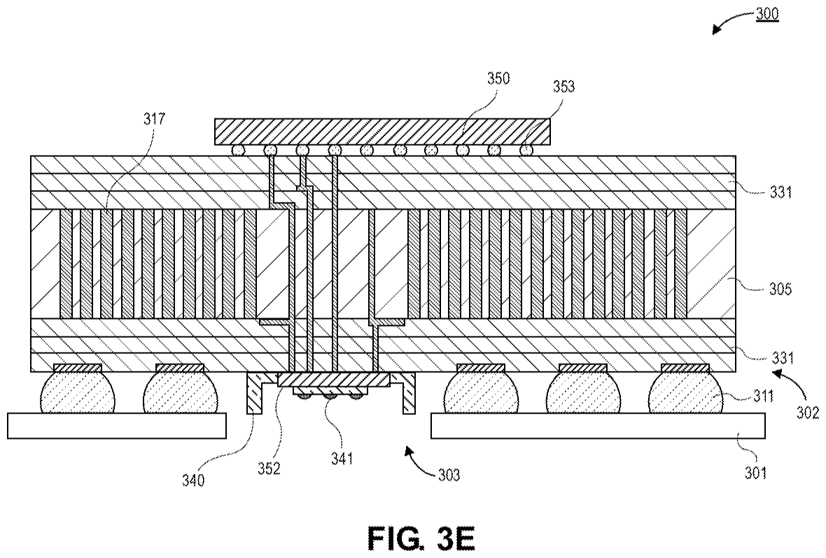

Referring now to FIG. 3A, a cross-sectional illustration of an electronic package 300 is shown, in accordance with an embodiment. In an embodiment, the electronic package comprises a board 301, such as a printed circuit board (PCB). The board 301 may be coupled to a package substrate 302 by interconnects 311. The interconnects 311 may comprise solder balls, sockets, or the like. A die 350 may be coupled to the package substrate 302 by first level interconnects (FLIs) 353. The die 350 may be a computational die, a system on chip (SOC), an interposer with computational die tiles, or any other suitable die.

In an embodiment, the package substrate 302 comprises a core 305. The core 305 may be a glass core or other optically clear material that is capable of being processed with a laser-assisted etching process, such as the process described above. In an embodiment, vias 317 may pass through a thickness of the core 305. The vias 317 illustrated in FIG. 3A are shown as having substantially vertical sidewalls. However, it is to be appreciated that the vias 317 may have sloped sidewalls. For example, the vias 317 may have hourglass shaped cross-sections characteristic of a laser-assisted etching process.

In an embodiment, one or more optical waveguides 320 may be embedded in the core 305. The optical waveguides 320 may be regions of buried exposed glass. That is, a laser exposure of the glass may result in a morphological change to provide the optical waveguides 320. For example, the core 305 may comprise amorphous glass, and the optical waveguides 320 may comprise crystalline glass. In an embodiment, an index of refraction of the optical waveguides 320 may be higher than the index of refraction of the core 305. As such, total internal reflection may occur within the optical waveguides 320 in order to route optical signals through the core 305.

In the illustrated embodiment, the optical waveguides 320 are horizontally oriented. That is, the optical waveguides 320 extend in a direction that is substantially parallel to a top surface of the core 305. The optical waveguides 320 may optically couple a connector 340 to a TRX die 352. As shown in FIG. 3A, the optical waveguides 320 appear to intersect the vias 317. This is done to illustrate both features in the same cross-sectional view. However, it is to be appreciated that the optical waveguides 320 are positioned between vias 317. That is, the vias 317 and the optical waveguides 320 do not intersect each other. In an embodiment, a cross-section of the optical waveguides (transverse to the illustrated plane) may be substantially circular or elliptical. Though it is to be appreciated that other cross-sectional shapes may also be obtained depending on the laser settings.

In an embodiment, the connector 340 may be attached to a side of the package substrate 302. For example, an adhesive may adhere the connector 340 to one or both of the core 305 and the buildup layers 331. In an embodiment, the connector 340 may comprise a lens 341 for optically coupling to external optical cables (not shown).

In an embodiment, the TRX die 352 may be placed into a hole formed into the core 305. The hole may be formed with the laser-assisted etching process. The TRX die 352 may be embedded in a transparent fill material 351. A transparent fill material 351 allows for optical signals to pass between the TRX die 352 and the optical waveguide 320. In an embodiment, the TRX die 352 may be an edge emitting laser device. The TRX die 352 may communicate with the die 350 by electrical signals that pass over vias and traces through the buildup layers 331. Power and ground may be provided to the TRX die 352 through solder balls connecting to vias 317 below the TRX die 352.

Referring now to FIG. 3B, a cross-sectional illustration of an electronic package 300 is shown, in accordance with an additional embodiment. Instead of having horizontally oriented optical waveguides 320, the embodiment shown in FIG. 3B includes vertically oriented optical waveguides 320. In an embodiment, the optical waveguides 320 may pass through an entire thickness of the core 305. In an embodiment, the optical path (indicated by the dashed lines) is from a bottom surface of the die 350, through the top buildup layers 331, through the optical waveguides 320 in the core, and through the bottom buildup layers 331 to the connector 340. In order to allow for optical connections below the package substrate 302, a hole 303 may be formed through the board 301.

In an embodiment, transparent fill material 354 may be formed in holes through the buildup layers 331 along the optical path. In some embodiments, there is no waveguide within the transparent fill material 354. In such instances the distance the optical path propagates through the transparent fill material 354 is minimal (e.g., approximately 100 μm or less), and losses are not significant. In other embodiments, optical waveguides may be provided through the buildup layers 331 to further reduce losses.

In the illustrated embodiment, there are no dedicated TRX dies. Instead, the transceiver functionality may be implemented on the die 350. In order to optically couple to the optical waveguides 320 below, the die 350 may have a VCSEL architecture. As such, a 2D array of lasers or photodiodes (PDs) can be arranged to provide even greater bandwidth density.

Referring now to FIG. 3C, a cross-sectional illustration of an electronic package 300 is shown, in accordance with an embodiment. The electronic package 300 may be substantially similar to the electronic package 300 in FIG. 3B, with the exception of there being a dedicated TRX die 352. As shown, the TRX die 352 may be embedded in the top buildup layers 331. A transparent fill material 355 may surround the TRX die 352. The TRX die 352 may be electrically coupled to the die 350 by traces and vias in the buildup layers 331. In other embodiments, the TRX die 352 may be provided in a recess in the core 305, similar to the TRX dies 352 in FIG. 3A. By providing the TRX die 352 between the optical waveguides 320 and the die 350, losses are reduced compared to the embodiment in FIG. 3B. This is because optical signals do not have to pass through the top buildup layers 331.

The bottom of the TRX die 352 may be optically coupled to optical waveguides 320 through the core 305. Similar to the embodiment in FIG. 3B, a transparent fill material 354 may fill a hole through the bottom buildup layers 331 to allow optical signals to pass from the optical waveguides 320 to the connector 340. Similar to the embodiment in FIG. 3B, the connector 340 may sit in a hole 303 through the board 301.

Referring now to FIG. 3D, a cross-sectional illustration of an electronic package 300 is shown, in accordance with an additional embodiment. The electronic package 300 in FIG. 3D may be substantially similar to the electronic package 300 in FIG. 3C, with the exception of the location of the TRX die 352. As shown in FIG. 3D, the TRX die 352 may be embedded in the bottom buildup layers 331. As such, only electrical signals need to pass through the core 305. The vias 317 through the core 305 that electrically couple the TRX die 352 to the die 350 may be formed with laser-assisted etching processes. In an embodiment, the vias 317 may have sloped sidewalls. For example, the vias 317 may have an hourglass shaped cross-section.

In an embodiment, the optical path from the TRX die 352 may pass through a transparent fill material 354 in the bottom buildup layers 331 and continue to the connector 340 on the bottom of the package substrate 300. In an embodiment, a hole 303 in the board 301 is provided to accommodate the connector 340.

Referring now to FIG. 3E, a cross-sectional illustration of an electronic package 300 is shown, in accordance with another embodiment. The electronic package 300 in FIG. 3E may be substantially similar to the electronic package 300 in FIG. 3D, with the exception of the positioning of the TRX die 352. Instead of being part of the package substrate 302, the TRX die 352 may be integrated into the connector 340. Such an embodiment may alleviate some of the TRX die 352 to connector 340 alignment and reduce assembly complexity. The bill of materials for the package substrate 302 may also be reduced by shifting the TRX die 352 to the connector 340.

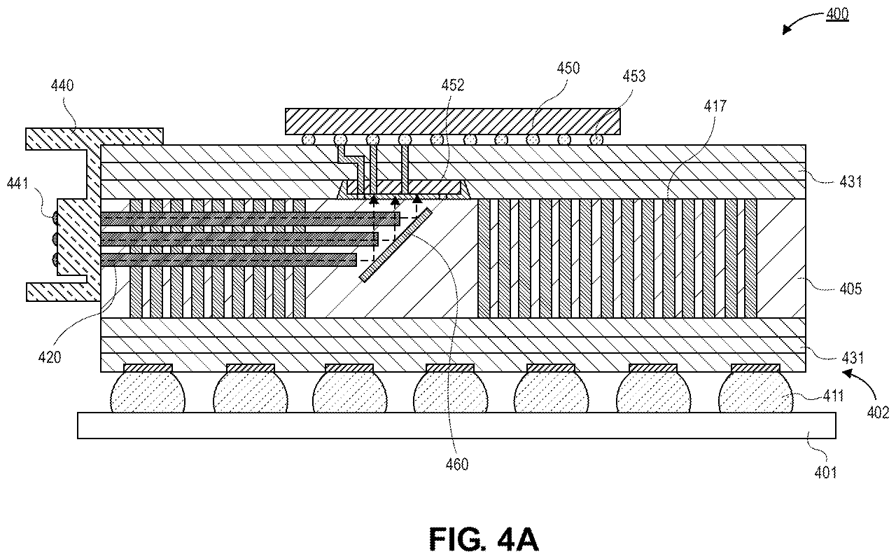

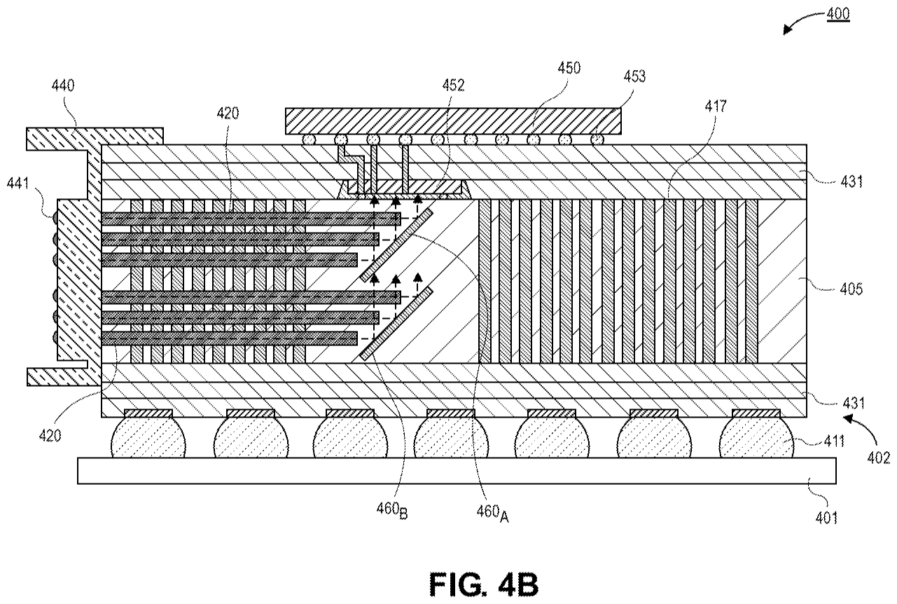

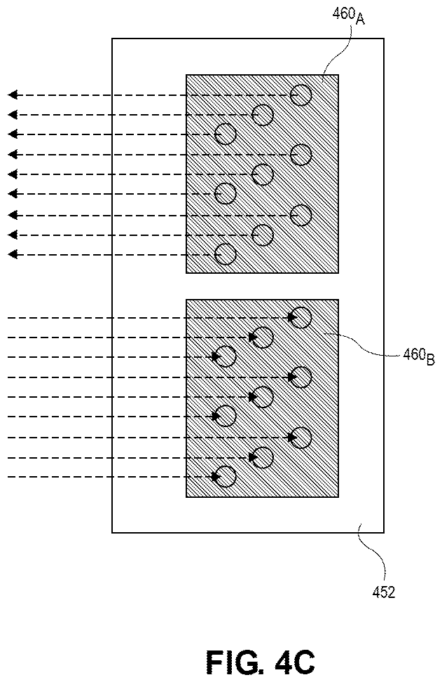

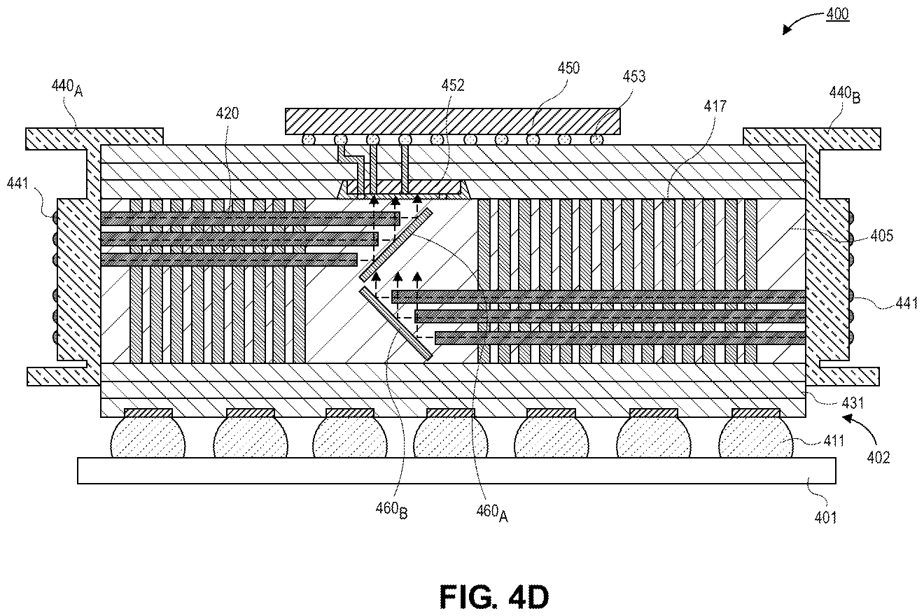

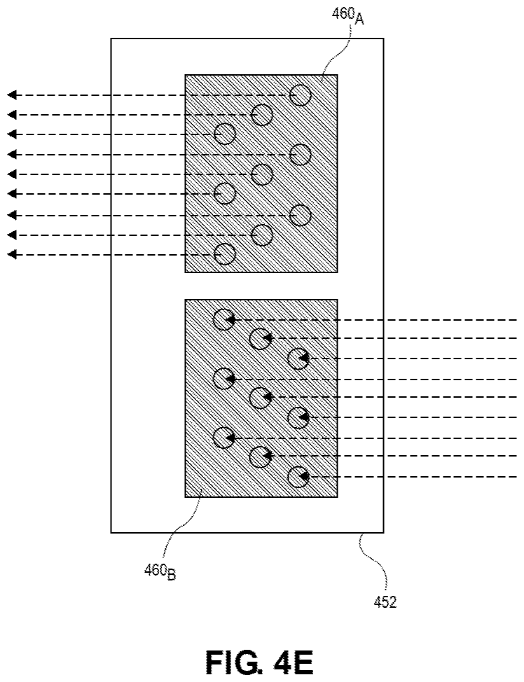

In FIGS. 3B-3E, TRX dies 352 with VCSEL configurations are able to be used to create 2D arrays for optical routing. However, the vertical configurations result in the need to provide a hole 303 in the board 301 to accommodate the connector 340. Accordingly, embodiments also include architectures that allow for VCSEL TRX dies 352 with connectors 340 attached to the side of the package substrate 302. As such, no modification is needed to the board 301. Examples of such embodiments are shown in FIGS. 4A-4E.

Referring now to FIG. 4A, a cross-sectional illustration of an electronic package 400 is shown, in accordance with an embodiment. In an embodiment, the electronic package 400 comprises a board 401 connected to a package substrate 402 by interconnects 411. A die 450 is connected to the package substrate 402 by FLIs 453. In an embodiment, the package substrate 402 may comprise a glass core 405 and buildup layers 431 above and below the glass core 405. Through core vias 417 may be provided through a thickness of the core 405. The vias 417 may have sloped sidewalls characteristic of laser-assisted etching processes. For example, the vias 417 may have hourglass shaped cross-sections.

In an embodiment, optical waveguides 420 may be embedded in the core 405. The optical waveguides 420 may be the same material as the core 405, but with a different crystal structure. For example, a laser exposure process may provide a crystalline crystal structure to the optical waveguides 420 compared to an amorphous structure for the core 405. The optical waveguides 420 may have an index of refraction that is greater than the index of refraction of the core 405. This provides the ability to have total internal reflection. The optical waveguides 420 may optically couple a mirror 460 to a connector 440. The connector 440 may comprise an array of lenses 441, such as a 2D array of lenses.

In an embodiment, the optical waveguides 420 extend in a substantially horizontal direction that is substantially parallel to a surface of the core 405. In an embodiment, the optical waveguides 420 may be provided at various z-heights in the core 405. As such a 2D array of optical waveguides 420 may be provided in some embodiments.

In an embodiment, the optical waveguides 420 may terminate proximate to the embedded mirror 460. The mirror may be at an approximately 45° angle relative to the horizontal surfaces of the core 405. The 45° angle allows for the optical signals to turn 90° to be oriented vertically so that the optical path (indicated by the dashed lines) can be routed to a bottom of the TRX die 452 which is capable of accommodating the 2D array using a VCSEL architecture. In an embodiment, the mirror 460 may be fabricated with a laser-assisted etching process. For example, the mirror 460 may be blind via plane that is formed into the core at an angle. The mirror 460 may comprise copper, though other reflective materials may also be used in some embodiments.

As shown, ends of the optical waveguides 420 stop short from reaching the surface of the mirror 460. If the optical waveguides 420 were to end at the mirror 460 the manufacturability of the device may be complicated. This is because the etching process used to etch out the trench for the mirror 460 would also etch out the connected optical waveguides 420. Keeping the optical waveguides 420 separate from the mirror 460 ensures that the optical waveguides 420 are protected from etching processes. In an embodiment, unexposed portions of the core 405 separate the end of the optical waveguides 420 from the mirror 460. For example, the spaces between the optical waveguides 420 and the mirror 460 may be between approximately 5 μm and approximately 25 μm.

Similar to the embodiments described above, the vias 417 and the optical waveguides 420 are shown as intersecting for convenience in the figure. However, it is to be appreciated that the waveguides 420 are positioned between the vias 417 and there is no intersection between the waveguides 420 and the vias 417 in the actual devices.

Referring now to FIG. 4B, a cross-sectional illustration of an electronic package 400 is shown, in accordance with an additional embodiment. The electronic package 400 in FIG. 4B may be substantially similar to the electronic package 400 in FIG. 4A, with the exception of there being two mirrors 460_{A} and 460_{B}. This may allow for a vertical or otherwise spatial separation between different groups of signals. For example, a first group of signals may reflect off of the first mirror 460_{A}, and a second group of signals may reflect off of the second mirror 460_{B}. The first group of signals may be outgoing signals (e.g., from a laser that emits vertically), and the second group of signals may be incoming signals (e.g., received by the PDs). In other embodiments, the different groups of signals may be different channels or any other segmentation of the signals. While two mirrors 460_{A} and 460_{B} are shown, it is to be appreciated that more than two mirrors 460 may be included in the core 405 to accommodate any number of signals.

In FIG. 4B, the mirrors 460_{A} and 460_{B} are vertically oriented for ease of illustration. A plan view illustration in FIG. 4C illustrates the mirrors 460_{A} and 460_{B} being adjacent to each other. The mirrors 460_{A} and 460_{B} may be at the same depth in the core 405 or they may be at different depths. The TRX die 452 is shown unshaded to not obscure the underlying mirrors 460. As indicated by the circles on each mirror 460, the optical signals can be arranged in a 2D array in order to increase bandwidth density. The optical signals (indicated by the dashed arrows) may exit the device when reflected by the first mirror 460_{A}, and the optical signals may enter the TRX die 452 when reflected by the second mirror 460_{B}.

Referring now to FIG. 4D, a cross-sectional illustration of an electronic package 400 is shown, in accordance with an additional embodiment. The electronic package 400 in FIG. 4D may be substantially similar to the electronic package 400 in FIG. 4B, with the exception of the mirrors 460_{A} and 460_{B} having reflective surfaces that are 90 degrees opposed to each other (i.e., orthogonal to each other). As such, a first connector 440A may be on a first edge of the core 405, and a second connector 440B may be on a second edge of the core 405 opposite from the first edge. That is, the mirrors 460_{A} and 460_{B} reflect light in opposite directions.

Referring now to FIG. 4E, a plan view illustration of the mirrors 460_{A} and 460_{B} in FIG. 4D is shown, in accordance with an embodiment. As shown, the oppositely angled mirrors 460_{A} and 460_{B} may be adjacent to each other. In some embodiments, the mirrors 460_{A} and 460_{B} are at the same z-height, while in other embodiments the mirrors 460_{A} and 460_{B} are at different z-heights. In an embodiment, outgoing signals may reflect off of the first mirror 460_{A}, and incoming signals may reflect off of the second mirror 460_{B}. Though it is to be appreciated that the grouping of signals between mirrors may be any suitable configuration.

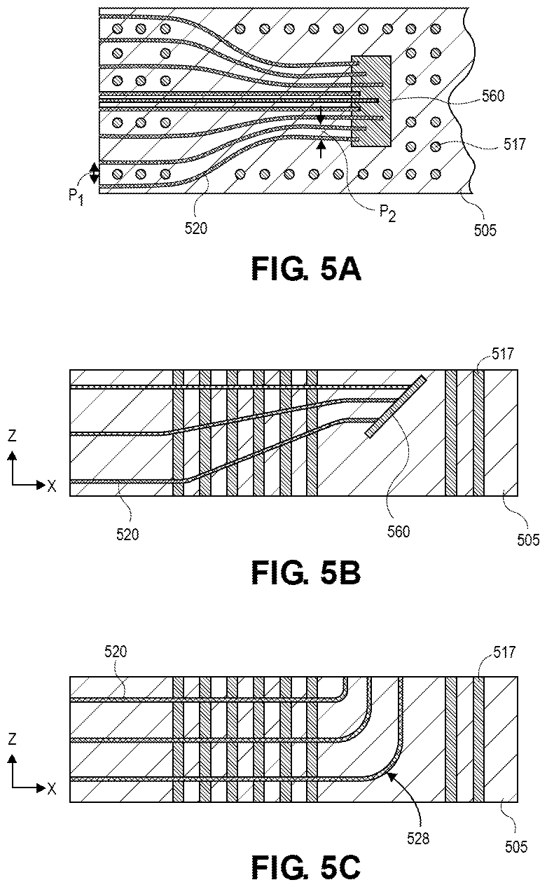

The way the optical waveguides are formed using a laser process allows for optical routing to be competed on the substrate in non-traditional approaches. For example, the optical waveguides may include bends or turns (i.e., left and right) and/or can pass through multiple z-heights in the core (i.e., up and down). FIGS. 5A-5C provide examples of how the optical waveguides 520 can be routed.

Referring now to FIG. 5A, a plan view illustration of a core 505 is shown, in accordance with an embodiment. The core 505 may comprise a plurality of vias 517 and a mirror 560. The vias 517 and the mirror 560 may be fabricated with a laser-assisted etching process. A plurality of optical waveguides 520 may extend from an edge of the core 505 to the mirror 560. The optical waveguides 520 may have a first pitch P₁ at the edge of the core 505, and the optical waveguides 520 may have a second pitch P₂ at the mirror 560. The second pitch P₂ may be smaller than the first pitch P₁. That is, the optical waveguides 520 may fan out towards the edge of the core 505. The larger first pitch P₁ allows for easier assembly of external optical cables, while still allowing a high density of optical waveguides 520 at the mirror 560.

Referring now to FIG. 5B, a cross-sectional illustration of a core 505 is shown, in accordance with an additional embodiment. In the illustrated embodiment, the optical waveguides 520 are shown bending in the vertical direction (z-direction). Similar to the fanning out in the horizontal plane shown in FIG. 5A, the optical waveguides 520 are able to fan out in the z-direction as well.

Referring now to FIG. 5C, a cross-sectional illustration of a core 505 is shown, in accordance with an additional embodiment. As shown, the optical waveguides 520 are able to make a 90° turn 528. As such, the mirror 560 may be omitted in some embodiments. Additionally, while a single 90° turn is made, a more gradual turn or multiple turns may be made in order to maintain total internal reflection along the optical waveguide 520.

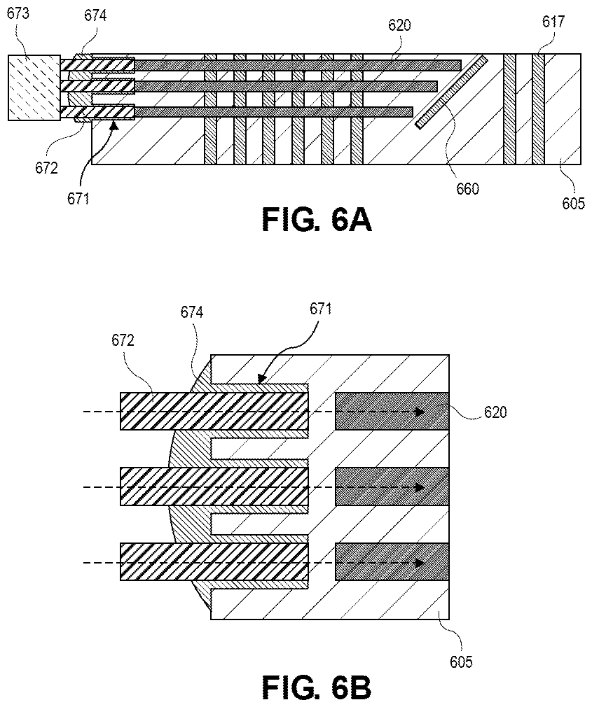

Referring now to FIG. 6A, a cross-sectional illustration of a core 605 is shown, in accordance with an additional embodiment. The core 605 may comprise vias 617 and a mirror 660. The vias 617 and the mirror 660 may be formed with a laser-assisted etching process. The laser-assisted etching process may further be used to form slots 671 at the edge of the core 605. The slots 671 may accommodate external fibers 672 of a fiber bundle 673. The slots 671 align the fibers 672 to optical waveguides 620 in the core. The fibers 672 may be adhered into the slots by a transparent fill material 674.

Referring now to FIG. 6B, a zoomed in cross-sectional illustration of the core 605 that more clearly illustrates the slots 671 is shown, in accordance with an embodiment. As shown, the ends of the slots 671 are spaced away from ends of the optical waveguides 620. That is, a portion of the core 605 is between the end of the slots 671 and the ends of the optical waveguides 605. This spacing may be between approximately 5μ and approximately 25 μm. Maintaining this spacing allows for the slots to be etched out during the etching process without also removing the morphologically changed structure of the optical waveguides 605.

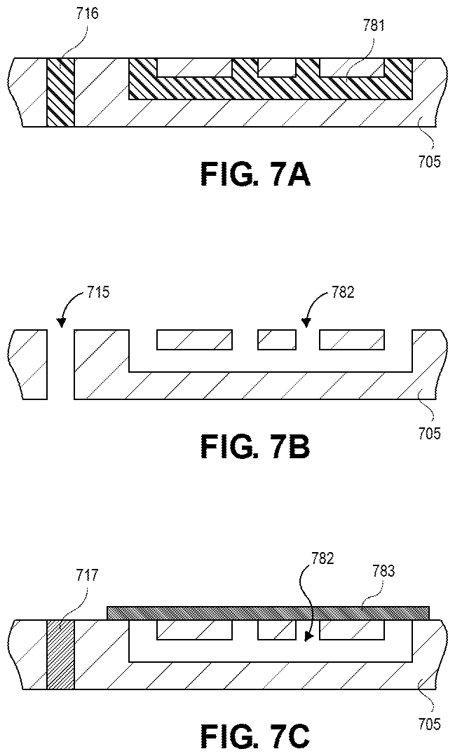

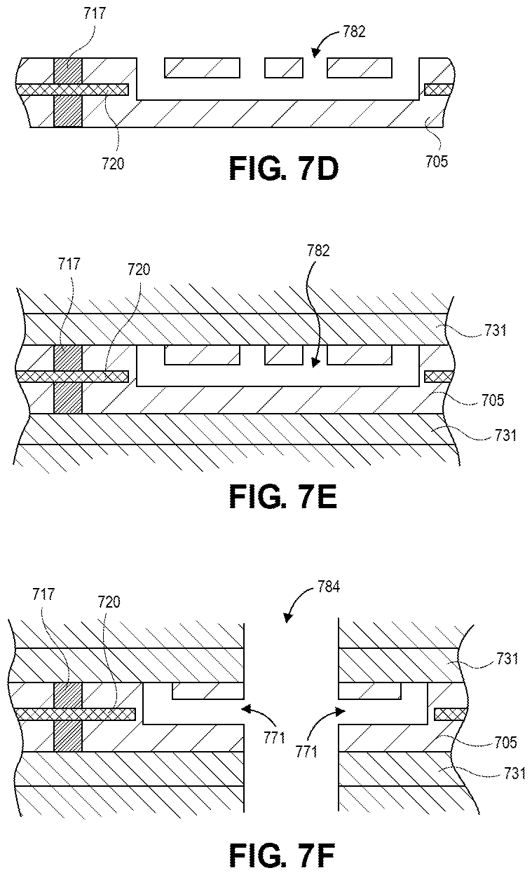

Referring now to FIGS. 7A-7F, a series of cross-sectional illustrations depicting a process for forming a core with slots is shown, in accordance with an embodiment.

Referring now to FIG. 7A, a cross-sectional illustration of the core 705 is shown, in accordance with an embodiment. In an embodiment, a laser is used to expose regions 781 and 716 of the core 705. The exposed regions experience a morphological change that makes the exposed regions 781 and 716 more susceptible to an etching process. The exposed region 716 may be used for a via, and the exposed regions 781 are provided to form the slots.

Referring now to FIG. 7B, a cross-sectional illustration of the core 705 after an etching process removes the exposed regions 781 and 716 to form openings 782 and 715 is shown, in accordance with an embodiment. In an embodiment, the vertical portions of the openings 782 allow for complete removal of the buried portion of the exposed regions 781.

Referring now to FIG. 7C, a cross-sectional illustration of the core 705 after a via 717 is disposed in the opening 715 is shown, in accordance with an embodiment. In an embodiment, the opening 782 is protected from the metal deposition by a mask 783. The mask 783 allows for the opening 782 to remain clear in order to form the slots.

Referring now to FIG. 7D, a cross-sectional illustration of the core 705 after optical waveguides 720 are formed is shown, in accordance with an embodiment. In an embodiment, the optical waveguides 720 may be formed with a laser exposure process similar to the laser exposure shown in FIG. 7A. As shown, the ends of the optical waveguides 720 may terminate before reaching the opening 782. While shown as intersecting the via 717, it is to be appreciated that the via 717 and the waveguide 720 do not intersect in actuality.

Referring now to FIG. 7E, a cross-sectional illustration of the core 705 after buildup layers 731 are disposed over the core 705 is shown, in accordance with an embodiment. In an embodiment, the buildup layers 731 are disposed over a top surface and a bottom surface of the core 705. The buildup layers 731 may also cover the vertical portions of the opening 782.

Referring now to FIG. 7F, a cross-sectional illustration of the core 705 after singulation is shown, in accordance with an embodiment. As shown, the opening 782 is now converted into a slot 771 that extends to the edge of the singulated cores 705. The slot 771 may be sized to receive an external fiber (e.g., from a fiber bundle).

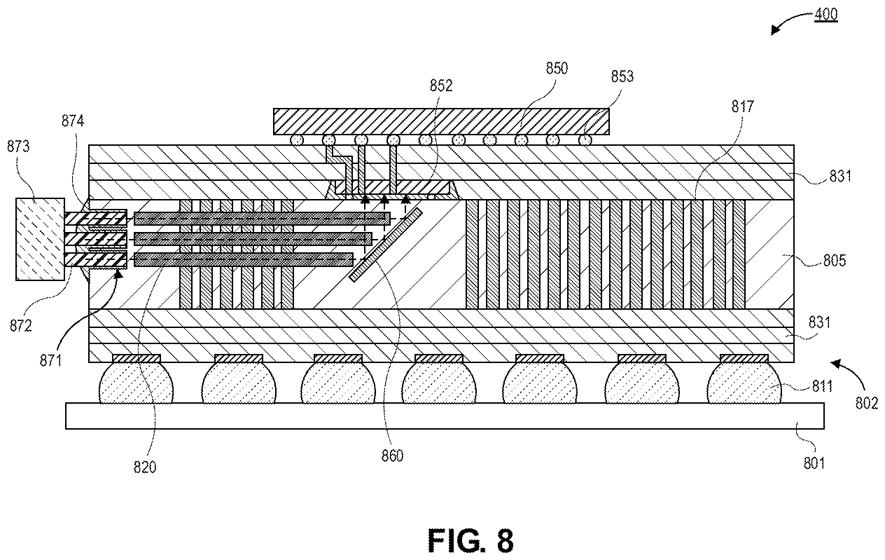

Referring now to FIG. 8, a cross-sectional illustration of an electronic package 800 is shown, in accordance with an additional embodiment. The electronic package 800 may comprise a board 801 and a package substrate 802 coupled to the board 801 by interconnects 811. A die 850 may be coupled to the package substrate 802 by FLIs 853. In an embodiment, the package substrate 802 comprises a core 805 and buildup layers 831. In an embodiment, vias 817 and a mirror 860 are provided in the core 805. The vias 817 and the mirror 860 may be fabricated with a laser-assisted etching process. The mirror may electrically couple optical signals that pass along optical waveguides 820 to a TRX die 852. The optical waveguides 820 may be substantially similar to any of the optical waveguides in accordance with embodiments described herein.

In an embodiment, an external connection to the optical waveguides 820 may be made by a fiber bundle 873. Individual fibers 872 may be inserted into slots 871 formed into an edge of the core 805. The fibers 872 may be secured by a transparent adhesive. The slots 871 may be formed with a laser-assisted etching process, as described above. In an embodiment, an end of the slots 871 may be spaced away from the optical waveguides 820 by a portion of the core 805. While the fiber bundle 873 and slot 871 configuration is shown with a core 805 architecture that comprises a mirror 860, it is to be appreciated that embodiments may include fiber bundle 873 and slot 871 architectures with any of the core 805 architectures in accordance with embodiments described herein.

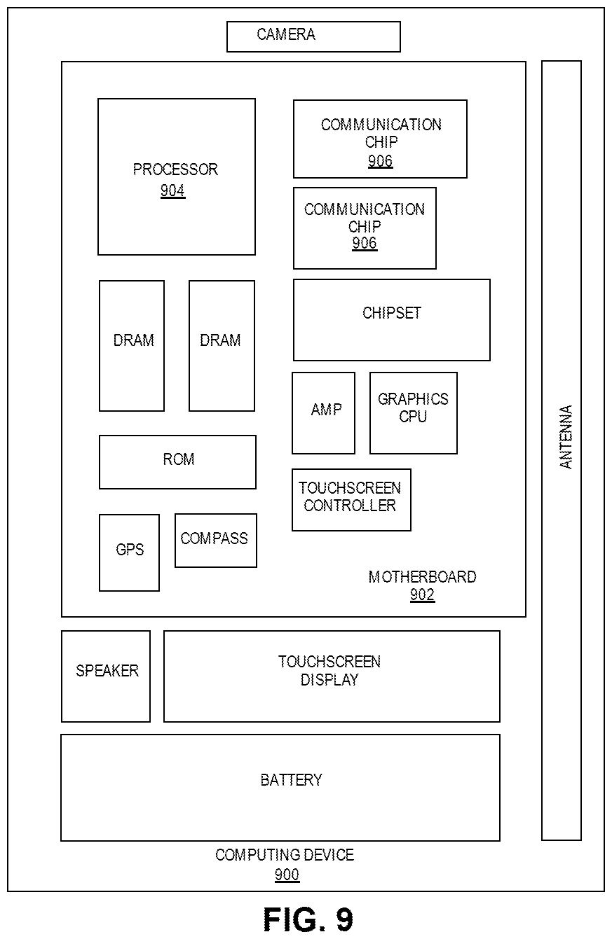

FIG. 9 illustrates a computing device 900 in accordance with one implementation of the invention. The computing device 900 houses a board 902. The board 902 may include a number of components, including but not limited to a processor 904 and at least one communication chip 906. The processor 904 is physically and electrically coupled to the board 902. In some implementations the at least one communication chip 906 is also physically and electrically coupled to the board 902. In further implementations, the communication chip 906 is part of the processor 904.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 906 enables wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 906 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 900 may include a plurality of communication chips 906. For instance, a first communication chip 906 may be dedicated to shorter range wireless communications such as Wi-Fi and Bluetooth and a second communication chip 906 may be dedicated to longer range wireless communications such as GPS, EDGE, GPRS, CDMA, WiMAX, LTE, Ev-DO, and others.

The processor 904 of the computing device 900 includes an integrated circuit die packaged within the processor 904. In some implementations of the invention, the integrated circuit die of the processor may be part of an electronic package that comprises a core with embedded optical waveguides formed with a laser exposure process, in accordance with embodiments described herein. The term “processor” may refer to any device or portion of a device that processes electronic data from registers and/or memory to transform that electronic data into other electronic data that may be stored in registers and/or memory.

The communication chip 906 also includes an integrated circuit die packaged within the communication chip 906. In accordance with another implementation of the invention, the integrated circuit die of the communication chip may be part of an electronic package that comprises a package substrate with a core with embedded optical waveguides formed with a laser exposure process, in accordance with embodiments described herein.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

Example 1: a package substrate, comprising: a core; a photonics die embedded in the core; and an optical waveguide embedded in the core, wherein the optical waveguide optically couples the photonics die to an edge of the core.

Example 2: the package substrate of Example 1, further comprising: electrical vias through a thickness of the core, wherein the electrical vias have an hourglass shaped cross-section.

Example 3: the package substrate of Example 1 or Example 2, wherein the optical waveguide has a circular or elliptical cross-section.

Example 4: the package substrate of Examples 1-3, further comprising: buildup layers over a top surface and a bottom surface of the core.

Example 5: the package substrate of Examples 1-4, wherein the optical waveguide runs substantially parallel to a top surface of the core along an entire length of the optical waveguide.

Example 6: the package substrate of Examples 1-5, wherein the optical waveguide is the same material as the core, and wherein a crystal structure of the optical waveguide is different than a crystal structure of the core.

Example 7: the package substrate of Example 6, wherein the core is glass, and wherein the crystal structure of the optical waveguide is crystalline and wherein the crystal structure of the core is amorphous, or wherein the crystal structure of the optical waveguide is amorphous and wherein the crystal structure of the core is crystalline.

Example 8: the package substrate of Examples 1-7, wherein a refractive index of the optical waveguide is higher than a refractive index of the core.

Example 9: an electronic package, comprising: a package substrate, wherein the package substrate comprises: a core; an optical waveguide embedded in the core; and a buildup layer over the core; and a die coupled to the package substrate, wherein the die has an optical transceiver portion, and wherein the optical transceiver portion is optically coupled to the optical waveguide.

Example 10: the electronic package of Example 9, further comprising: a transparent fill in a trench through the buildup layer, wherein the optical transceiver portion is optically coupled to the optical waveguide through the transparent fill.

Example 11: the electronic package of Example 10, wherein the optical waveguide is vertically oriented and passes from a first surface of the core to a second surface of the core that is opposite from the first surface.

Example 12: the electronic package of Example 11, further comprising: a second buildup layer under the core; and a second transparent fill in a second trench through the second buildup layer, wherein the second transparent fill is optically coupled to the optical waveguide.

Example 13: the electronic package of Examples 9-12, wherein the die is embedded in the buildup layer.

Example 14: the electronic package of Examples 9-13, further comprising: a mirror embedded in the core, wherein the optical waveguide is optically coupled to the optical transceiver portion by the mirror.

Example 15: the electronic package of Example 14, wherein the mirror is oriented approximately 45° relative to a surface of the core.

Example 16: a package substrate, comprising: a glass core; and a plurality of optical waveguides embedded in the glass core, wherein the plurality of optical waveguides comprise glass with a different crystal structure than the glass core.

Example 17: the package substrate of Example 16, wherein the plurality of optical waveguides have a first pitch at an edge of the glass core and a second pitch within the glass core, wherein the second pitch is smaller than the first pitch.

Example 18: the package substrate of Example 16 or Example 17, wherein the plurality of optical waveguides are all at a single depth within the glass core.

Example 19: the package substrate of Example 16 or Example 17, wherein the plurality of optical waveguides are at multiple depths within the glass core.

Example 20: the package substrate of Examples 16-19, further comprising: a mirror embedded within the glass core, wherein ends of the plurality of optical waveguides are spaced away from the mirror by a portion of the glass core.

Example 21: the package substrate of Examples 16-20, further comprising: a plurality of slots into an edge of the glass core, wherein individual ones of the plurality of optical waveguides are aligned with individual ones of the plurality of slots.

Example 22: the package substrate of Example 21, wherein a portion of the glass core separates an end of the plurality of slots from ends of the optical waveguides.

Example 23: an electronic system, comprising: a board; a package substrate coupled to the board, wherein the package substrate comprises: a glass core; optical waveguides embedded in the glass core; and a connector optically coupled to the optical waveguides; and a photonics transceiver coupled to the package substrate, wherein the photonics transceiver is optically coupled to the optical waveguides.

Example 24: the electronic system of Example 23, wherein the connector passes through a hole in the board.

Example 25: the electronic system of Example 23, wherein the connector is attached to an edge of the glass core.

What is claimed is:

1. A package substrate, comprising:
a core;
a photonics die embedded in the core; and
an optical waveguide embedded in the core, wherein the optical waveguide optically couples the photonics die to an edge of the core.

2. The package substrate of claim 1, further comprising:
electrical vias through a thickness of the core, wherein the electrical vias have an hourglass shaped cross-section.

3. The package substrate of claim 1, wherein the optical waveguide has a circular or elliptical cross-section.

4. The package substrate of claim 1, further comprising:
buildup layers over a top surface and a bottom surface of the core.

5. The package substrate of claim 1, wherein the optical waveguide runs substantially parallel to a top surface of the core along an entire length of the optical waveguide.

6. The package substrate of claim 1, wherein the optical waveguide is the same material as the core, and wherein a crystal structure of the optical waveguide is different than a crystal structure of the core.

7. The package substrate of claim 6, wherein the core is glass, and wherein the crystal structure of the optical waveguide is crystalline and wherein the crystal structure of the core is amorphous, or wherein the crystal structure of the optical waveguide is amorphous and wherein the crystal structure of the core is crystalline.

8. The package substrate of claim 1, wherein a refractive index of the optical waveguide is higher than a refractive index of the core.

9. An electronic package, comprising:
a package substrate, wherein the package substrate comprises:
a core;
an optical waveguide embedded in the core; and
a buildup layer over the core; and
a die coupled to the package substrate, wherein the die has an optical transceiver portion, and wherein the optical transceiver portion is optically coupled to the optical waveguide.

10. The electronic package of claim 9, further comprising:
a transparent fill in a trench through the buildup layer, wherein the optical transceiver portion is optically coupled to the optical waveguide through the transparent fill.

11. The electronic package of claim 10, wherein the optical waveguide is vertically oriented and passes from a first surface of the core to a second surface of the core that is opposite from the first surface.

12. The electronic package of claim 11, further comprising:
a second buildup layer under the core; and
a second transparent fill in a second trench through the second buildup layer, wherein the second transparent fill is optically coupled to the optical waveguide.

13. The electronic package of claim 9, wherein the die is embedded in the buildup layer.

14. The electronic package of claim 9, further comprising:
a mirror embedded in the core, wherein the optical waveguide is optically coupled to the optical transceiver portion by the mirror.

15. The electronic package of claim 14, wherein the mirror is oriented approximately 45° relative to a surface of the core.

16. A package substrate, comprising:
a glass core; and
a plurality of optical waveguides embedded in the glass core, wherein the plurality of optical waveguides comprise glass with a different crystal structure than the glass core.

17. The package substrate of claim 16, wherein the plurality of optical waveguides have a first pitch at an edge of the glass core and a second pitch within the glass core, wherein the second pitch is smaller than the first pitch.

18. The package substrate of claim 16, wherein the plurality of optical waveguides are all at a single depth within the glass core.

19. The package substrate of claim 16, wherein the plurality of optical waveguides are at multiple depths within the glass core.

20. The package substrate of claim 16, further comprising:
a mirror embedded within the glass core, wherein ends of the plurality of optical waveguides are spaced away from the mirror by a portion of the glass core.

21. The package substrate of claim 16, further comprising:
a plurality of slots into an edge of the glass core, wherein individual ones of the plurality of optical waveguides are aligned with individual ones of the plurality of slots.

22. The package substrate of claim 21, wherein a portion of the glass core separates an end of the plurality of slots from ends of the optical waveguides.

23. An electronic system, comprising:
a board;
a package substrate coupled to the board, wherein the package substrate comprises:
a glass core;
optical waveguides embedded in the glass core; and
a connector optically coupled to the optical waveguides; and
a photonics transceiver coupled to the package substrate, wherein the photonics transceiver is optically coupled to the optical waveguides.

24. The electronic system of claim 23, wherein the connector passes through a hole in the board.

25. The electronic system of claim 23, wherein the connector is attached to an edge of the glass core.
